(19) United States
(12) Patent Application Publication
(10) Pub. No.: US 2013/0012848 A1
(43) Pub. Date: Jan. 10, 2013

(54) Massage Device

(76) Inventor: Joseph Forrest, Garfield Heights, OH (US)

(21) Appl. No.: 13/069,490

(22) Filed: Jul. 6, 2011

(51) Int. Cl. A61H 1/00

(52) U.S. Cl. 601/19

(57) ABSTRACT

The invention describes a massage device capable of providing several different sensual effects to the recipient of the massage.

### BACKGROUND OF THE INVENTION

1. Field of the Invention

The purpose of this invention is to provide a massage device with a rotatable region capable of delivering air flow over an affected area of the recipient of a massage.

2. Description of the Art Practices

Mouatt, in United States Patent Application Publication 2010/0191161 A1 published Jul. 29, 2010 describes an exercise apparatus that comprises a plurality of modules which are able to be detachably secured relative to each other in a plurality of configurations.

United States Patent Application Publication 2006/0265822 A1 by McKay published Nov. 30, 2006 recites a cleaning apparatus includes a handle, a support coupled to the handle and a cleaning element mountable on the support. The support is fixed to the handle or is rotatably coupled to the handle for rotation by a drive motor mounted in the handle. The cleaning element may include bristles extending from a flexible mat fixed about the support or about a core mountable on the support. A cleaning sheet is off and retain debris including particulates from treated surfaces. The windable about the support, the core or the cleaning element, including over and through the bristles, for dual cleaning action.

Linzell, in United States Patent Application Publication 2006/0210774 A1 published Sep. 21, 2006 describes a surface treatment tool formed from a thin sheet of flexible material, typically a polymer, shaped to store and dispense fluid, scrub, abrade, scrape tool is useful for cleaning in domestic, industrial, cosmetics, personal or medical care fields. The tool comprises an array of closely spaced hollow mushroom shaped protrusions that store then release fluids during rubbing via perforated faces, the upstanding mushroom shapes carrying soft rubbing faces with harder scraper edges constitute the operable face with gaps between faces leading into a sunken labyrinth into which loosened debris are scraped up and retained.

United States Patent Application Publication 2005/0066457 A1 by McKay published Mar. 31, 2005 recites a cleaning apparatus includes a handle, a support coupled to the handle and a cleaning element mountable on the support. The support is fixed to the handle or is rotatably coupled to the handle for rotation by a drive motor mounted in the handle. The cleaning element may include bristles extending from a flexible mat fixed about the support or about a core mountable on the support. A cleaning sheet is windable about the support, the core or the cleaning element, including over and through the bristles, for dual cleaning action.

U.S. Pat. No. 4,846,159 issued to Anzai et al., Jul. 11, 1989 describes a massage apparatus adapted to be utilized for various massage manner comprising at least two balls which are provided with a multiple numbers of projections on the outer periphery thereof and a case for enclosing and retaining the balls in a rotatable state by rotatably supporting a pair of projections of the balls and in attachable/detachable manner.

Chen, in United States Patent Application Publication 2006/0276732 A1 published Dec. 7, 2006 describes a roller massager having a handle and two rollers mounted on two sides of the handle. When pushing/pulling the massager, the rollers roll on human body to provide a massaging effect. When in use, the axis of the rollers and the length of the handle contain an angle which is not right angle. In use of the roller massager, the rollers can inward squeeze the muscle of a user to achieve a kneading and massaging effect.

U.S. Pat. No. 3,858,579 issued to Ching on Jan. 7, 1975 illustrates a human body massaging apparatus has an inflexible, body contacting cylindrical roller, rotatably mounted on a left and a right handgrip, so that the apparatus may be rolled over a human body to produce a massaging action. The handgrips are cylindrical in shape and of the same diameter as the body contacting, cylindrical roller, permitting the handgrips and the cylindrical roller to contact the human body simultaneously. Hands are stated to easily be slid back and forth between the same size roller and handles for alternately braking the roller and permitting it to roll, thereby intermittently stretching the skin. A cylindrical roller is composed of two half sections of cylindrical shape, attached to each other by a flexible shaft so that the half sections are capable of rotating independently of each other. This construction is stated to allow the cylindrical roller to be turned around contours of the human body.

Faroky, in U.S. Pat. No. 5,868,689 issued Feb. 9, 1999 discusses a hand held massaging device comprised of a first and second handle, a cord permanently fixed to the first handle and slidably fixed to the second handle. A resilient rubber ball having a hole axially through the center allowing the ball to be mounted on the cord between the two handles. Each handle and the ball have ball bearings where the cord passes through so that the ball can roll easily over the body part being massaged. A pair of snug fitting O rings hold the ball in place but the ball can be moved by rolling the O rings to a new position along the cord. A retaining ring assembly located on the cord just outside the slidable handle acts to retain the slidable handle in the desired position along the cord. In this way a user can space the handles and ball to the ideal location and can hold onto the handles and roll the massage ball over the desired body part in an easy way. The user can increase the effect of the massage ball by leaning his or her body weight against the ball and sandwiching the ball between the body part being massaged and a fixed surface such as a chair back, wall or floor. The hand held massage device is stated to also be used as a stretching type exercise device and can also be used as a jump rope.

United States Patent Application Publication 2008/0051020 A1 issued to van Esbroeck, et al., on Feb. 28, 2008 describes a device for treating products, in particular massaging meat products, comprises at least one treatment section with a space for receiving the products. Said space comprises a treatment device for treating the products. A discharge device is provided for discharging the products from the space of the treatment section. The discharge device can be brought into an active and an inactive operating state with the aid of an actuating device.

United States Patent Application Publication 2010/0010401A1 by Tudico, published Jan. 14, 2010 recites a This device comprises two parallel rollers which are used to work the skin and which are mounted in a casing so as to rotate about their respective axis. To treat the skin by aspiration in a reliable and effective manner, without using excessive vacuum levels, at least one of the rollers is hollow and delimits transverse aspiration passages. Those passages each have an outer end, which opens out on the periphery of the roller, and an inner end which, at least when the outer end is directed towards the skin, is designed to be connected to a vacuum source via a control means inside the roller. These passages are distributed about the periphery of the roller in such a way that, for each position of the roller about its axis, at least one of the passages has its outer end directed towards the skin and has its inner end in fluidic communication, via the control means, with the inner end of at least one other of the passages, of which the outer end opens out in a free volume defined inside the casing.

To the extent that the foregoing references are relevant to the present invention, they are herein specifically incorporated by reference. Certain portions of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### SUMMARY OF THE INVENTION

The invention is directed to a massage device that functions with a rolling motion. A heating element is included in the massage device to provide a warming sensation to the recipient of the massage. A fan is included in the massage device to facilitate air flow over the recipient of the massage.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1A is a top plan view of the device of the present invention;

FIG. 1B is side view of the device of the present invention;

FIG. 2 is a partially exposed view of according to FIG. 1B;

FIG. 3A is sectional view taken along lines 3A-3A;

FIG. 3B is sectional view taken along lines 3B-3B;

FIG. 4 is a partially exposed view of according to FIG. 1B; and,

FIG. 5 is a partial sectional view.

With more particular reference to the drawings the following is set forth.

### DETAILED DESCRIPTION OF THE INVENTION

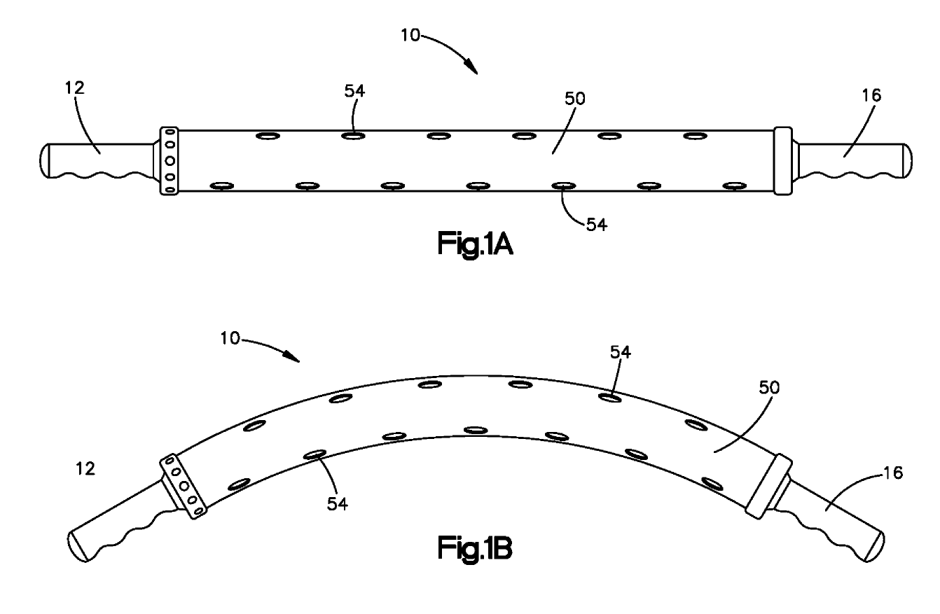

The invention per FIG. 1A shows a massage device 10 having a massage device first handle 12. A massage device cylindrical element 20 is fixedly connected to the massage device first handle 12. At the opposite end of the massage device cylindrical element 20 from the massage device first handle 12 is a massage device detachable handle 16.

The massage device cylindrical element 20 is relatively flexible so that it may be deformed per FIG. 1B in to various positions. The massage device cylindrical element 20 has a massage device cylindrical element wall 22.

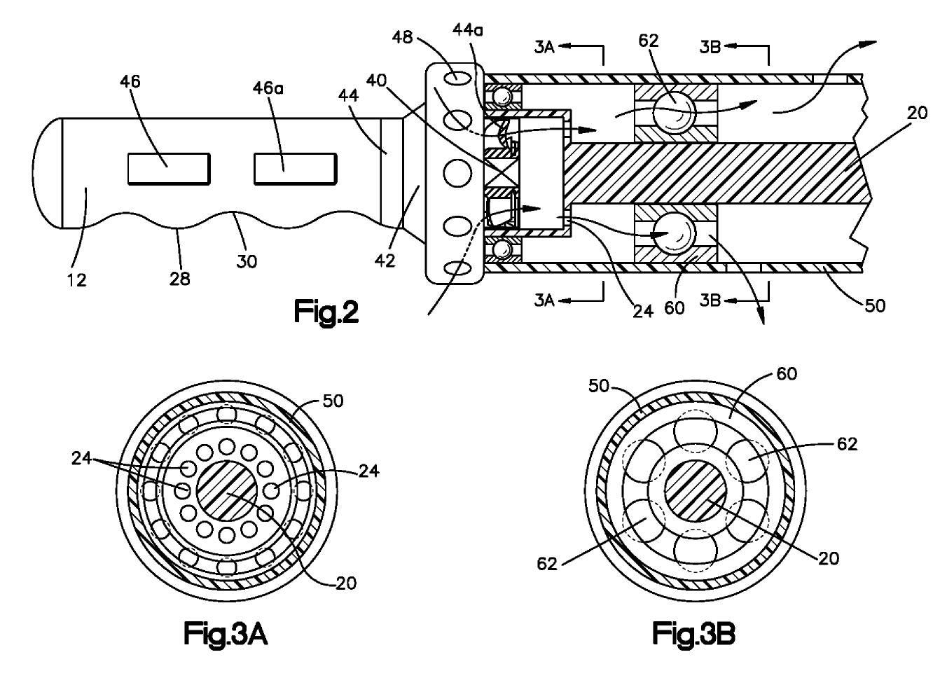

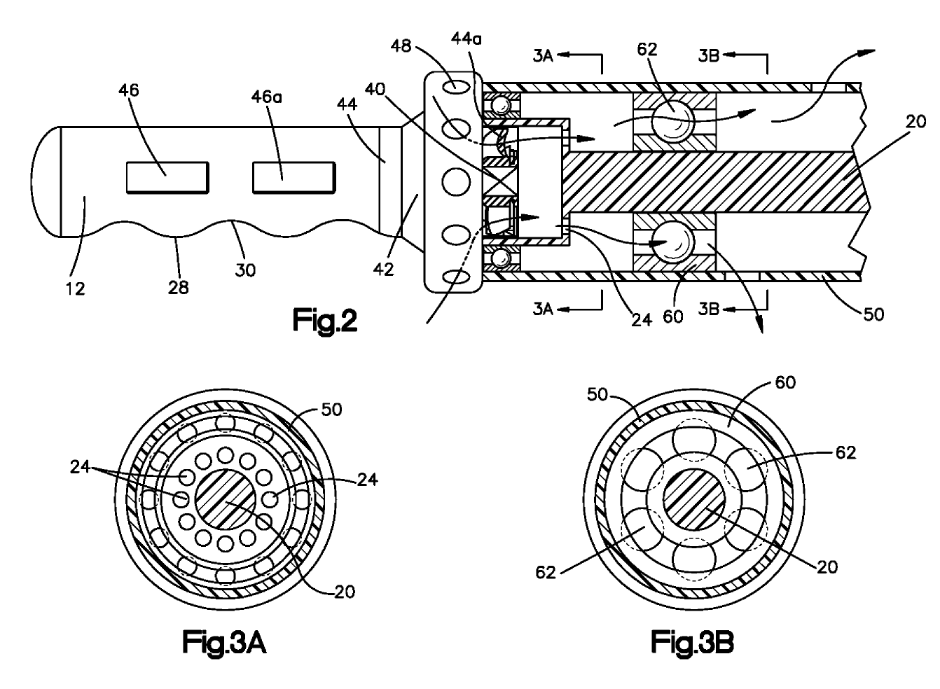

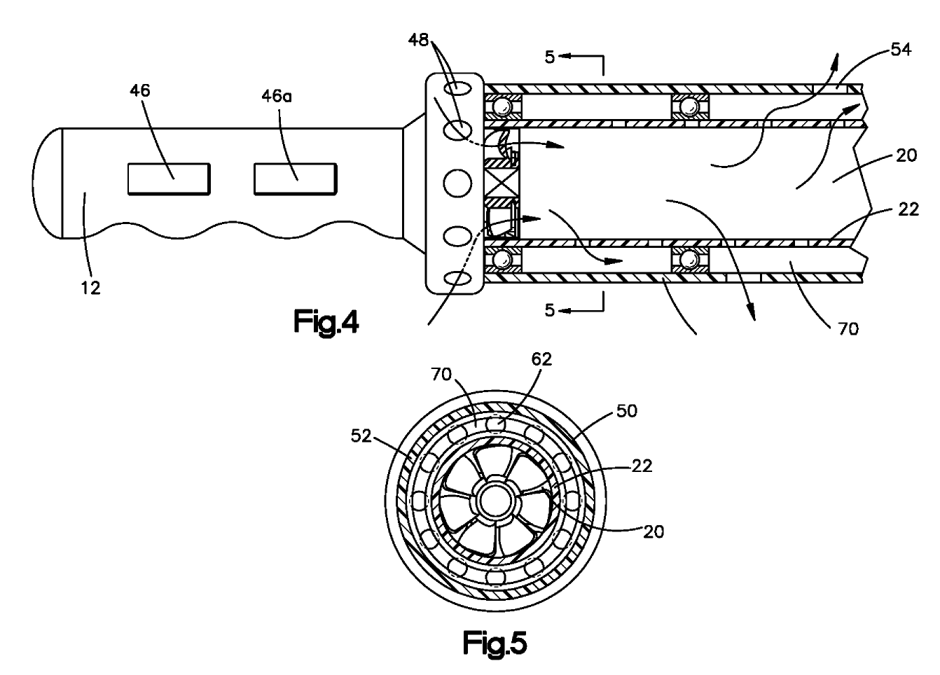

Per FIG. 2 the massage device first handle 12 has massage device cylindrical element external vent opening at least partially defined by an air intake 48 opening. The massage device first handle 12 has a handle land 28 and handle groove 30.

The 12 has a heating element and/or vibration generator 40. For convenience the heating element and/or vibration generator 40 re-presents both. It is understood that both the heating element and/or vibration generator 40 and heating element and/or vibration generator 40 may be separate elements. A heating element and/or vibration generator control 42 controls the heating element and/or vibration generator 40. For convenience the heating element and/or vibration generator control 42 represents both 42. Again the heating element and/or vibration generator control 42 it is understood that both heating element and/or vibration generator control 42 and heating element and/or vibration generator control 42 may be separate elements.

A fan 44a is fixedly connected to the massage device first handle 12. The fan 44a is controlled by a fan motor control 44. A temperature control and temperature read out 46 is mounted in the massage device first handle 12.

A vibration generator control read out 46a is also mounted in the massage device first handle 12. If desired the temperature control and temperature read out 46 and the vibration generator control read out 46a may employ a selector switch (not shown) to provide alternate readouts of desired information. A massage device textured sleeve 50 is employed in the present invention. The massage device textured sleeve 50 is hollow with the cavity within the massage device textured sleeve 50 being defined by a massage device textured sleeve wall 52. The massage device textured sleeve 50 is flexible.

The massage device sleeve wall textured 52 has a plurality massage device textured sleeve openings 54. The outer surface of the massage device textured sleeve wall 52 may have indentations, protuberances, or a combination of both. A ball bearing raceway 60 is fixedly connected to the massage device first handle 12. A second ball bearing raceway 60 is fixedly connected to the massage device detachable handle 16.

A plurality of ball bearings 62 are positioned within ball bearing raceway 60. A massage device channel 70 is in fluid communication with the ambient environment via the massage device cylindrical element external vent opening. The massage device channel 70 is generally defined by massage device cylindrical element wall 22 and the massage device textured sleeve wall 52.

The massage device channel 70 is also in fluid communication with environment through the massage device textured sleeve openings 54. The massage device detachable handle 16 has a locking mechanism (not shown) not shown to permit connection with the massage device cylindrical element 20.

The massage device 10 is assembled by positioning the massage device textured sleeve 50 over the massage device cylindrical element 20. The massage device textured sleeve 50 contacts the plurality of ball bearings 62 in the ball bearing raceway 60. The massage device detachable handle 16 is then locked into place to the massage device cylindrical element 20.

In operation the assembled massage device 10 is rolled over a mammalian subject to provide a soothing experience by the recipient of the massage. If desired a vibratory or heating effect may be obtained by operating the heating element and/or vibration generator 40. The fan 44a may be operated to provide air flow from the air intake 48 opening through the massage device channel 70 and eventually through the massage device textured sleeve opening 54 to the subject.

From the above description of the invention, those skilled in the art will perceive improvements, changes and modifications. Such improvements, changes and modifications within the skill of the art are intended to be covered by the appended claims.

What is claimed is:

1. A massage device comprising:
a massage device first handle;
a massage device detachable handle;
a massage device cylindrical element connected between said massage device first handle and said massage device detachable handle;
a massage device textured sleeve;
a heating element;
a vibration generator;
a fan, for when in use, to force air from within a channel formed by said massage device cylindrical element and said massage device textured sleeve.

2. The massage device according to claim 1 wherein said massage device cylindrical element is flexible.

3. The massage device according to claim 1 wherein said heating element is operatively connected with a temperature control.

4. The massage device according to claim 1 wherein said heating element 40 is connected with a temperature read out.

5. The massage device according to claim 1 wherein said vibration generator 40 is operatively connected to a vibration generator control.

6. The massage device according to claim 1 wherein said massage device first handle has one or more air intakes.

7. The massage device according to claim 1 wherein said massage device textured sleeve has one or more openings to permit air flow through said openings.

8. The massage device according to claim 1 wherein said massage device first handle has a plurality of lands and groves disposed along the outer surface thereof.

9. The massage device according to claim 1 wherein said massage device textured sleeve is flexible.

10. A method of providing a massage to a mammal comprising utilizing a massage device comprising:
a massage device first handle;
a massage device detachable handle;
a massage device cylindrical element connected between said massage device first handle and said massage device detachable handle;
a massage device textured sleeve;
a heating element;
a vibration generator;
a fan, for when in use, to force air from within a channel formed by said massage device cylindrical element and said massage device textured sleeve;
to provide a massage by applying the massage device textured sleeve with pressure against an outer body surface of the mammal.

11. The method of claim 10 wherein said massage device cylindrical element is flexible.

12. The method of claim 10 wherein said heating element provides heat to an outer body surface of the mammal.

13. The method of claim 10 wherein said vibration generator provides a vibratory sensation to an outer body surface of the mammal.

14. The method of claim 10 wherein the mammal is human.
